(19) United States
(12) Patent Application Publication
(10) Pub. No.: US 2024/0214686 A1
(43) Pub. Date: Jun. 27, 2024

(54) BI-DIRECTIONAL ROTATION OF AN ELECTRONIC DEVICE USING MODULATED VIBRATION FOR SUBJECT IMAGE TRACKING

(71) Applicant: MOTOROLA MOBILITY LLC, WILMINGTON, DE (US)

(72) Inventors: AMIT KUMAR AGRAWAL, BANGALORE (IN); BILL RYAN, LIBERTYVILLE, IL (US); DANIEL M VACURA, CHICAGO, IL (US); JEFFREY S VANHOOF, GURNEE, IL (US)

(21) Appl. No.: 18/146,425

(22) Filed: Dec. 26, 2022

(51) Int. Cl. H04N 23/695; H04N 23/51; H04N 23/61

(52) U.S. Cl. CPC H04N 23/695; H04N 23/51; H04N 23/61

(57) ABSTRACT

An electronic device, a method, and a computer program product provide vibrating the electronic device for bidirectional tracking of a subject identified within a field of view of an image capturing device. In response to determining that the subject is moving in a first direction, a controller of the electronic device triggers vibratory component(s) to vibrate in a first mode that results in rotating in the first direction to maintain the movable subject within a field of view of the image capturing device. In response to determining that the subject is moving in an opposite second direction, the controller triggers the vibratory component(s) to vibrate in a second mode that results in the housing rotating in the second direction to maintain the movable subject within the field of view.

### BACKGROUND

### 1. Technical Field

The present disclosure relates generally to a mobile electronic device having a camera, and more particularly to a mobile electronic device having a camera and which performs subject image tracking.

### 2. Description of the Related Art

Electronic devices such as mobile phones, network servers, desktop workstations, laptops, and tablets are often equipped with a camera that is used to capture images and videos of subjects, including video for podcasts and communication sessions. Outside of physical movement of the device by the user, conventional electronic devices have a limited capability to aim the device's camera to maintain a moving subject being captured within a field of view of the camera. Some conventional electronic devices have a mechanical gimbal to aim the camera. Also, some conventional electronic devices have the capability to simulate aiming the camera by digitally selecting cropped portions of a large digital image. The subject is constrained to move only within the simulated gimbal limits of the camera. The subject is similarly constrained to move only within the total fixed field of view of the camera in order to maintain the subject of the video within the field of view of the camera. To enable the subject to move freely around the electronic device, a camera operator or user has to move the device, which is inconvenient when the user is also the subject. In some instances, the subject of the video conspicuously repositions the device camera, detracting from the content of the video presentation.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts a functional block diagram of an electronic device that uses vibration to bidirectionally rotate to track a movable subject of a video, according to one or more embodiments;

FIG. 2 depicts a functional block diagram of an example electronic device that is configured as a communication device to communicate the video with communication networks and other wireless devices, according to one or more embodiments;

FIG. 3A depicts a top view of the electronic device rotating in a clockwise direction to track a subject within a field of view of an image capturing device (ICD), according to one or more embodiments;

FIG. 3B depicts a top view of the electronic device rotating in a counterclockwise direction to track a subject within a field of view of the ICD, according to one or more embodiments;

FIG. 4A depicts a front view of an example electronic device having a flip form factor in an open position, according to one or more embodiments;

FIG. 4B depicts a back view of an example electronic device having a flip form factor in an open position, according to one or more embodiments;

FIG. 4C depicts a three-dimensional view of the example electronic device having the flip form factor in a partially open position and placed in a tent orientation, according to one or more embodiments;

FIG. 4D depicts a three-dimensional view of the example electronic device having the flip form factor in the partially open position and placed in an L-shaped orientation, according to one or more embodiments;

FIG. 5A depicts a three-dimensional view of a base that upwardly presents a support surface within a raised exterior circular lip and having a central raised portion, according to one or more embodiments;

FIG. 5B depicts a three-dimensional view of the example electronic device in the partially open L-shaped configuration placed on the base of FIG. 5A, with a front-facing image capturing device being used to track a subject within a field of view, according to one or more embodiments;

FIG. 5C depicts a three-dimensional view of the example electronic device in the partially open L-shaped configuration placed on the base of FIG. 5A, with back-facing ICD being used to track the subject within the field of view, according to one or more embodiments;

FIGS. 6A-6B (FIG. 6) is a flow diagram presenting a method of selectively vibrating an electronic device for bidirectional rotation to track a subject moving within a field of view of an ICD, according to one or more embodiments; and

FIG. 7 is a flow diagram presenting a method of determining a current rate of rotation based on image recognition, according to one or more embodiments.

### DETAILED DESCRIPTION

According to one or more aspects of the present disclosure, an electronic system, a method, and a computer program product enable “hands free” video recording with 360° tracking of a subject in a field of view of an image capturing device (ICD). The electronic device includes a housing configured for positioning on a support surface. An ICD of the electronic device is positioned at an exterior of the housing to have a field of view that encompasses a movable subject. At least one vibratory component is received in the housing. The at least one vibratory component generates vibratory movement. A controller of the electronic device is communicatively connected to the ICD and the at least one vibratory component. The controller identifies the movable subject within an image stream received from the ICD. In response to determining that the movable subject is moving in a first direction, the controller triggers the at least one vibratory component to vibrate in a first mode that results in the housing rotating in the first direction to maintain the movable subject within the field of view. In response to determining that the movable subject is moving in a second direction that is opposite to the first direction, the controller triggers the at least one vibratory component to vibrate in a second mode that results in the housing rotating in the second direction to maintain the movable subject within the field of view.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

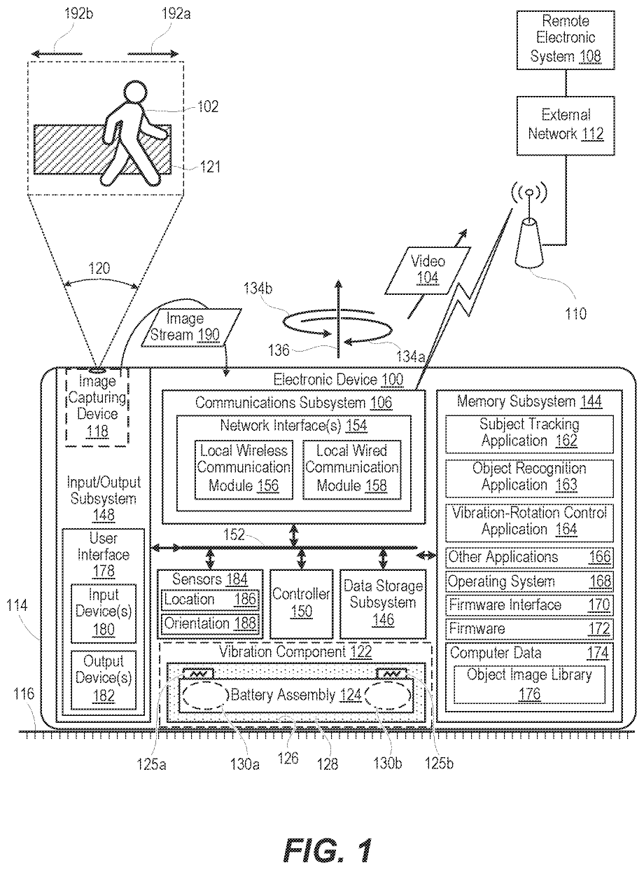

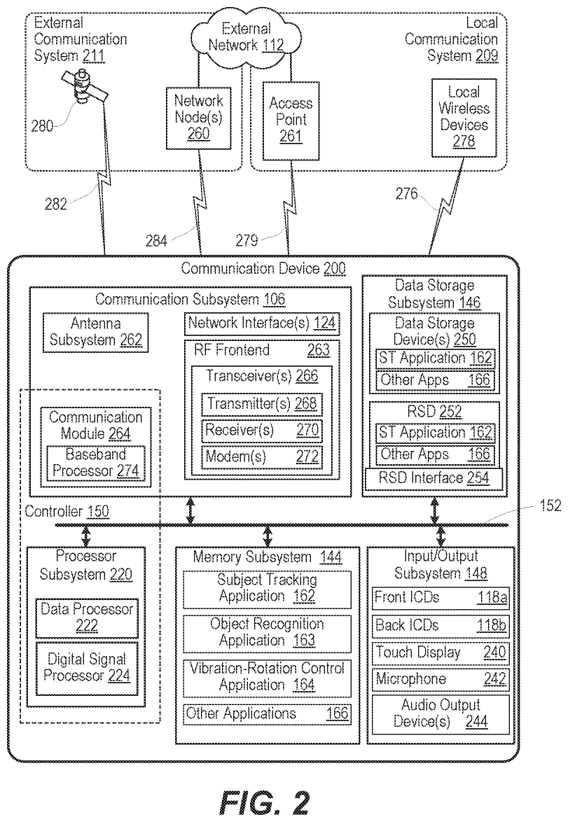

FIG. 1 depicts a functional block diagram of electronic device 100 that uses vibration to bidirectionally rotate to track movable subject 102 within a field of view of an integrated image capturing device (ICD) 118. Electronic device 100 can be one of a host of different types of devices, including but not limited to, an infant monitoring system, a mobile cellular phone, satellite phone, or smart phone, a laptop, a netbook, an ultra-book, a networked smart watch, networked sports/exercise watch, and/or a tablet computing device or similar device. As more completely presented as communication device 200 of FIG. 2, which is described hereafter, electronic device 100 can also be a device supporting wireless communication. In these implementations, electronic device 100 can be utilized as, and also be referred to as, a system, device, subscriber unit, subscriber station, mobile station (MS), mobile, mobile device, remote station, remote terminal, user terminal, terminal, user agent, user device, a Session Initiation Protocol (SIP) phone, a wireless local loop (WLL) station, a personal digital assistant (PDA), computer workstation, a handheld device having wireless connection capability, a computing device, or other processing devices connected to a wireless modem. Most importantly, it is appreciated that the features described herein can be implemented with a display device of various other types of electronic devices that are not necessarily a communication device. The specific presentation or description herein of a mobile communication device in addition to a data processing system as different examples of electronic device 100 are for example only, and not intended to be limiting on the disclosure. In one aspect, electronic device 100 may operate standalone without necessarily communicating with other electronic devices when generating video 104. In another aspect, electronic device 100 may include communications subsystem 106 that communicates video 104 with remote electronic system 108 via network node 110 and external network 112.

Housing 114 of electronic device 100 is configured for positioning on support surface 116, such as a floor or top surface of a desk or other furniture. ICD 118 of electronic device 100 is positioned at an exterior of housing 114 to have field of view (FOV) 120 that encompasses movable subject 102 and stationary components 121. At least one vibratory component 122 is received in housing 114 and generates vibratory movement. In one or more embodiment, vibratory component 122 includes a moving assembly of battery assembly 124 and one or more vibrator elements 125a-125b that are contained within cavity 126. In one or more embodiments, cavity 126 within vibration component 122 is lined with resilient material 128 to transfer vibrational movements. Battery assembly 124 provides an elongate mass that has first portion 130a that is laterally offset from a center of mass of electronic device 100 and second portion 130b laterally offset opposite to first portion 130a from the center of mass. In a first mode, first vibrator element 125a attached to battery assembly 124 oscillates or vibrates first portion 130a to cause first rotational direction 134a around central axis 136. In a second mode, second vibrator element 125b attached to battery assembly 124 oscillates or vibrates second portion 130b to cause second rotational direction 134b around central axis 136. In one or more alternate embodiments, first and second vibrator elements 125a, 125b can be controlled to provide different levels of vibration intensity that corresponds to a speed/rate and amplitude/intensity of the rotation.

Referring now to the specific component makeup and the associated functionality of the presented components, electronic device 100 includes communications subsystem 106, memory subsystem 144, data storage subsystem 146, and input/output subsystem 148 managed by controller 150. System interlink 152 communicatively connects controller 150 with communications subsystem 106, memory subsystem 144, data storage subsystem 146, and input/output subsystem 148. Communications subsystem 106 may include one or more network interfaces 154 such as low power local wireless communication module 156 and local wired communication module 158 to communicatively couple to external networks 112.

Memory subsystem 144 includes program code for applications, such as subject tracking application 162, object recognition application 163, vibration-rotation control application 164, and other applications 166. Memory subsystem 144 further includes operating system (OS) 168, firmware interface 170, such as basic input/output system (BIOS) or Uniform Extensible Firmware Interface (UEFI), and firmware 172. Memory subsystem 144 stores computer data 174 that is used by object recognition application 163, such as object image library 176 that supports recognizing movable subject 102 and stationary components 121.

In one or more embodiments, input/output subsystem 148 provides user interface device(s) 178 of one or more input devices 180, such as ICD 118, and one or more output devices 182. User interface device(s) devices 178 may enable user interaction with electronic device 100 using inputs and outputs that are one or more of visual, haptic, touch, sound, gesture, etc. In one or more embodiments, electronic device 100 includes movement sensors 184 that are responsive to positioning and movement of electronic device 100, such as location sensor 186 and orientation sensor 188.

According to aspects of the present disclosure, controller 150 is communicatively connected to ICD 118 and at least one vibratory component 122. Controller 150 identifies movable subject 102 within image stream 190 received from ICD 118. In response to determining that movable subject 102 is moving in first lateral direction 192a, controller 150 triggers at least one vibratory component 122 to vibrate in the first mode that results in housing 114 rotating in first rotation direction 134a to maintain movable subject 102 within FOV 120. In response to determining that movable subject 102 is moving in second lateral direction 192b that is opposite to first lateral direction 192a, controller 150 triggers at least one vibratory component 122 to vibrate in the second mode that results in housing 114 rotating in second rotation direction 134b to maintain movable subject 102 within FOV 120.

In one or more embodiments, controller 150 performs image object recognition to identify movable subject 102. Controller 150 performs image object recognition to identify one or more stationary components 121 contained in FOV 120. Controller 150 determines a current rotation rate of electronic device 100 based on spatial movement of one or more stationary components 121 in FOV 120. Controller 150 identifies a target rotation rate of electronic device 100 to maintain movable subject 102 within FOV 120 based on at least one of: (i) spatial offset of movable subject 102 from a center of FOV 120 and (ii) a rate and direction of spatial movement of movable subject 102 within FOV 120. Controller 150 modulates at least one of a vibration rate and a vibration amplitude of at least one vibratory component 122 in relation to a difference between the target rotation rate and the current rotation rate to maintain movable subject 102 within FOV 120.

In one or more embodiments, controller 150 is communicatively coupled to movement sensor 184 configured to detect a movement of electronic device 100 related to rotation rate. Controller 150 determines a target rotation rate of electronic device 100 to maintain movable subject 102 within FOV 120. Controller 150 receives, from movement sensor 184, a current rotation rate of electronic device 100. Controller 150 modulates at least one of a vibration rate and a vibration amplitude of vibration element(s) 125a-125b of at least one vibratory component 122 in relation to a difference between the target rotation rate and the current rotation rate.

FIG. 2 depicts communication device 200 that is configured to communicate with communication networks and other wireless devices and communicate a video generated using automatic subject tracking. Communication device 200 is an implementation of electronic device 100 (FIG. 1). Communication device 200 includes communications subsystem 106, memory subsystem 144, data storage subsystem 146, input/output subsystem 148, and controller 150, as previously described with regard to electronic device 100 (FIG. 1) but having additional functionality for cellular and wireless communication.

Controller 150 includes processor subsystem 220, which executes program code to provide operating functionality of communication device 200. Controller 150 manages, and in some instances directly controls, the various functions and/or operations of communication device 200. These functions and/or operations include, but are not limited to including, application data processing, communication with second communication devices, navigation tasks, image processing, and signal processing. In one or more alternate embodiments, communication device 200 may use hardware component equivalents for application data processing and signal processing. For example, communication device 200 may use special purpose hardware, dedicated processors, general purpose computers, microprocessor-based computers, micro-controllers, optical computers, analog computers, dedicated processors and/or dedicated hard-wired logic.

The software and/or firmware modules executed by processor subsystem 220 have varying functionality when their corresponding program code is executed by data processor(s) 222 or secondary processing devices within communication device 200 such as digital signal processor 224. Processor subsystem 220 can include other processors that are communicatively coupled internally or externally to data processor 222. Data processor 222 is communicatively coupled, via system interlink 152, to data storage subsystem 146 and memory subsystem 144. System interlink 152 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (system interlink 152) are illustrated in FIGS. 1-2, it is to be understood that more, fewer, or different interconnections may be present in other embodiments.

Processor subsystem 220 of controller 150 can execute program code of subject tracking application 162, object recognition application 163, and vibration-rotation control application 164 to configure communication device 200 to perform specific functions for controlling vibration to perform subject tracking. Processor subsystem 220 receives data from certain components of input/output subsystem 148 and presents data on certain components of input/output subsystem 148. In an example, input/output subsystem 148 includes front and back ICDs 118a-118b, touch display 240, microphone 242, and audio output device(s) 244.

Data storage subsystem 146 of communication device 200 includes data storage device(s) 250. Controller 150 is communicatively connected, via system interlink 152, to data storage device(s) 250. Data storage subsystem 146 provides applications, program code, and stored data on nonvolatile storage that is accessible by controller 150. For example, data storage subsystem 146 can provide a selection of applications and computer data, such as subject tracking application 162 and other application(s) 166. These applications can be loaded into memory subsystem 144 for execution by controller 150. In one or more embodiments, data storage device(s) 250 can include hard disk drives (HDDs), optical disk drives, and/or solid-state drives (SSDs), etc. Data storage subsystem 146 of communication device 200 can include removable storage device(s) (RSD(s)) 252, which is received in RSD interface 254. Controller 150 is communicatively connected to RSD 252, via system interlink 152 and RSD interface 254. In one or more embodiments, RSD 252 is a non-transitory computer program product or computer readable storage device. Controller 150 can access data storage device(s) 250 or RSD 252 to provision communication device 200 with program code, such as code for subject tracking application 162 and other application(s) 166.

Communication device 200 further includes communications subsystem 106 for communicating, using a cellular connection, with network node(s) 260 of external communication system 211 and for communicating, using a wireless connection, with wireless access point 261 of local communication system 209. Communications subsystem 106 includes antenna subsystem 262. Communications subsystem 106 includes radio frequency (RF) front end 263 and communication module 264. RF front end 263 includes transceiver(s) 266, which includes transmitter(s) 268 and receiver(s) 270. RF front end 263 further includes modem(s) 272. Communication module 264 of communications subsystem 106 includes baseband processor 274 that communicates with controller 150 and RF front end 263. Baseband processor 274 operates in a baseband frequency range to encode data for transmission and decode received data, according to a communication protocol. Modem(s) 272 modulate baseband encoded data from communication module 264 onto a carrier signal to provide a transmit signal that is amplified by transmitter(s) 268. Modem(s) 272 demodulates each signal received from external communication system 211 using by antenna subsystem 262. The received signal is amplified and filtered by receiver(s) 270, which demodulate received encoded data from a received carrier signal.

In one or more embodiments, controller 150, via communications subsystem 106, performs multiple types of cellular OTA or wireless communication with local communication system 209. Communications subsystem 106 can communicate via an over-the-air (OTA) connection 276 with local wireless devices 278. In an example, OTA connection 276 is a peer-to-peer connection, Bluetooth connection, or other personal access network (PAN) connection. In one or more embodiments, communications subsystem 106 communicates with one or more locally networked devices via a wireless local area network (WLAN) link 279 supported by access point 261. In one or more embodiments, access point 261 supports communication using one or more IEEE 802.11 WLAN protocols. Access point 261 is connected to external networks 112 via a cellular connection. In one or more embodiments, communications subsystem 106 communicates with GPS satellites 280 via downlink channel 282 to obtain geospatial location information. Communications subsystem 106 can communicate via an over-the-air (OTA) cellular connection 284 with network node(s) 260.

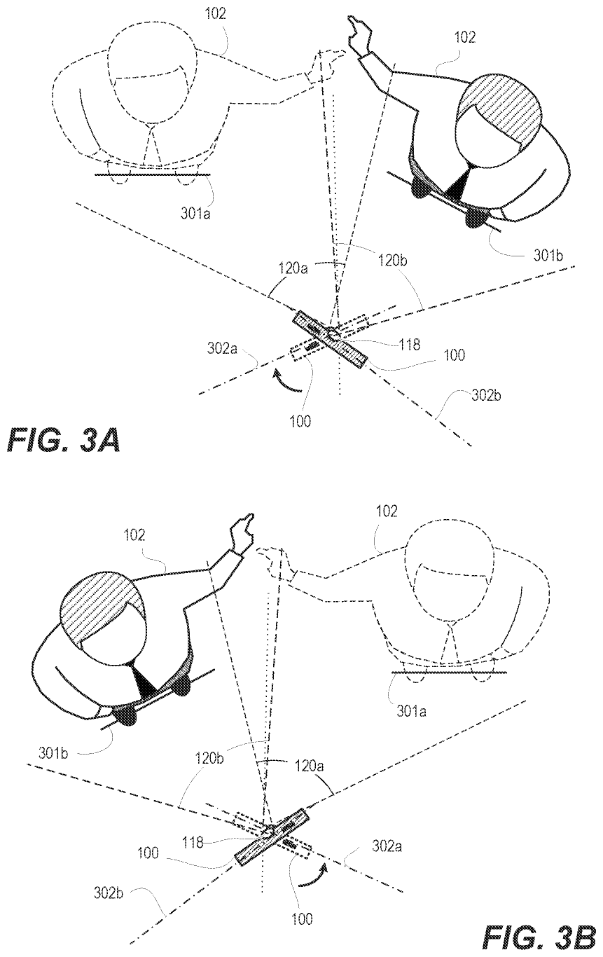

FIG. 3A depicts a top view of electronic device 100 rotating clockwise as depicted to track movable subject 102 within FOV 120 of ICD 118. In particular, at a first time, movable subject 102 is at first position 301a with electronic device 100 at a stationary location positioned at first rotation angle 302a. At a second time, movable subject 102 is at second position 301b that is to the right of first position 301a as depicted from a vantage point of electronic device 100 that is at second rotation angle 302b. FOV 120 of electronic device 100 at the first time rotates clockwise as viewed from above to FOV 120b at the second time as electronic device 100 vibrates in a first mode from first rotation angle 302a to second rotation angle 302b.

FIG. 3B depicts a top view of electronic device 100 rotating counterclockwise, as depicted, to track movable subject 102 within FOV 120 of ICD 118. In particular, at a first time, movable subject 102 is at first position 301a with electronic device 100 at a stationary location positioned at first rotation angle 302a. At a second time, movable subject 102 is at second position 301b that is to the left of first position 301a, as depicted from a vantage point of electronic device 100 that is at second rotation angle 302b. FOV 120 of electronic device 100 at the first time rotates counterclockwise, as viewed from above, to FOV 120b at the second time as electronic device 100 vibrates in a second mode from first rotation angle 302a to second rotation angle 302b.

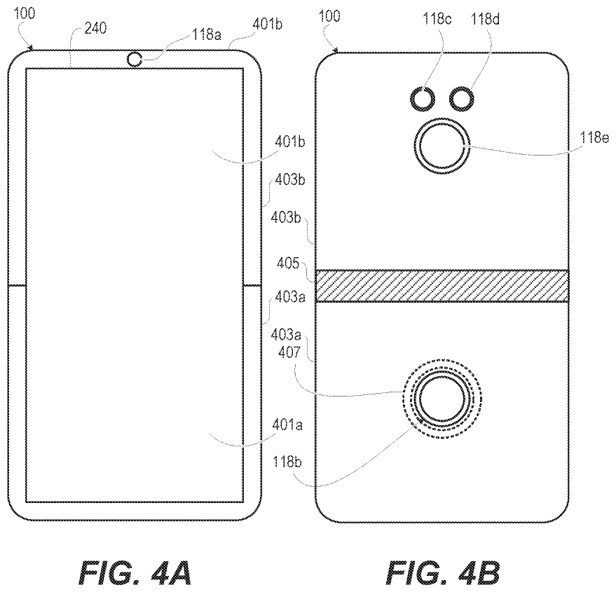

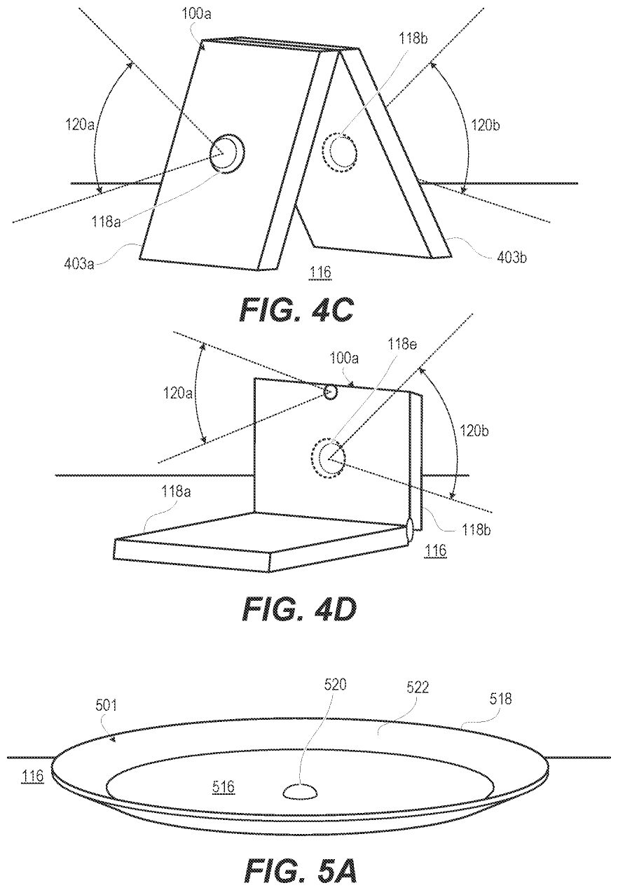

FIG. 4A depicts a front view of electronic device 100a having a flip form factor and in an open position to present bottom and top portions 401a-401b of touch display 240 respectively supported by first and second housings 403a-403b of housing 114. In one or more embodiments, touch display 240 is a flexible display having an excess portion that rolls or scrolls at one or both ends to lay flat on first and second housings 403a-403b. Front ICD 118a is exposed adjacent to top portion 401b of touch display 240 on second housing 403b. FIG. 4B depicts a back view of electronic device 100a in an open position. Hinge 405 couples first housing 403a to second housing 403b. First housing 403a is pivotable about hinge 405 relative to second housing 403b between a folded closed position and an unfolded open position. In one or more embodiments, second ICD 118b is exposed on a back side of first housing 403a. Third, fourth, and fifth ICDs 118c, 118d, and 118e are exposed on a backside of second housing 403b. In an example, third, fourth, and fifth ICDs 118c, 118d, and 118e may represent panoramic, macro, and telephoto cameras. In one or more embodiments, first housing 403a includes convex portion 407 exposed toward the back side. Convex portion 407 is aligned with a center of rotation of electronic device 100a and configured to contact support surface 116 (FIG. 1) for vibrational rotation with reduced frictional contact between housing 114 and support surface 116 (FIG. 1). Second housing 403b includes back ICDs 118b exposed toward the back side.

FIG. 4C depicts a three-dimensional view of example electronic device 100a having the flip form factor in a partially open position. Electronic device 100a is placed in a tent orientation, which looks like a capital Greek letter lambda “A”, on support surface 116. In the tent orientation, front ICD 118a exposed on a back side of second housing 403b is positioned to have a generally horizontal FOV 120a toward a first lateral side. Back ICD 118b exposed on second housing 403b is positioned to have a generally horizontal FOV 120b toward an opposite second lateral side. Electronic device 100a rotates in the tent position in response to bidirectional vibrations by at least one vibratory component 122 (FIG. 1).

FIG. 4D depicts a three-dimensional view of example electronic device 100 having the flip form factor in the partially open position and placed in an orientation that looks like capital letter “L”. In particular, the “L-shaped” orientation includes having first housing 403a placed or seated horizontally on support surface 116 with second housing 403b unfolded to stand approximately in a perpendicular position to a generally vertical orientation. In the L-shaped orientation, front ICD 118a exposed on a front side of second housing 403a is positioned to have a generally horizontal FOV 120a toward a first lateral side. Back ICD 118e exposed on a back side of second housing 403b is positioned to have a generally horizontal FOV 120b toward an opposite second lateral side. Electronic device 100a rotates in the L-shaped orientation in response to bidirectional vibrations by at least one vibratory component 122 (FIG. 1).

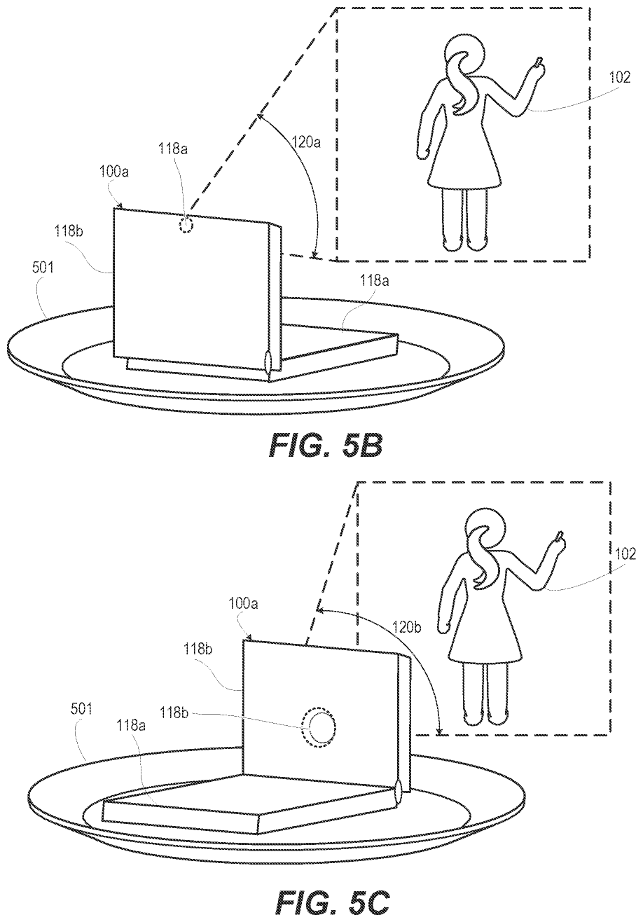

FIG. 5A depicts a three-dimensional view of base 501, which upwardly presents base support surface 516 with central raised portion 520 and surrounded by raised exterior circular lip 518. Base 501 is separate from electronic device 100 (FIG. 1). Base 501 is positionably placed upon stationary support surface 116. Material of base 501 may be selected to reduce noise generated by vibrational contact. In an example, base 501 includes upwardly presented concave surface 522 to resemble a saucer with an addition of central raised portion 520. Central raised portion 520 is positioned to support a center of rotation of electronic device 100 (FIG. 4D) in a L-shaped orientation to reduce frictional contact.

FIG. 5B depicts a three-dimensional view of electronic device 100 in the partially open position placed in the L-shaped orientation at a first rotation angle on base 501. Electronic device 100 tracks movable subject 102 within FOV 120a of front ICD 118a exposed on the front side of second housing 403b. FIG. 5C depicts a three-dimensional view of electronic device 100 in the partially open position placed in the L-shaped orientation on base 501. Electronic device 100 tracks movable subject 102 within FOV 120b of back ICD 118b exposed on the back side of second housing 403b.

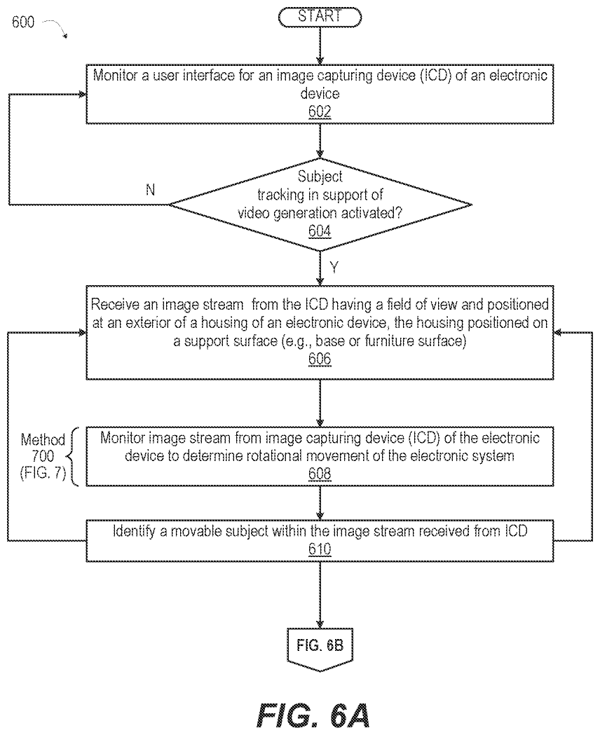

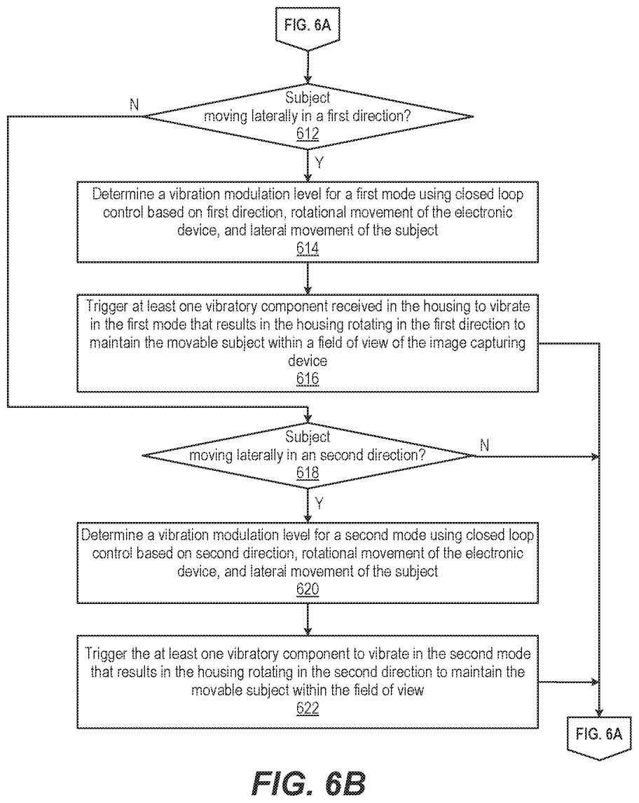

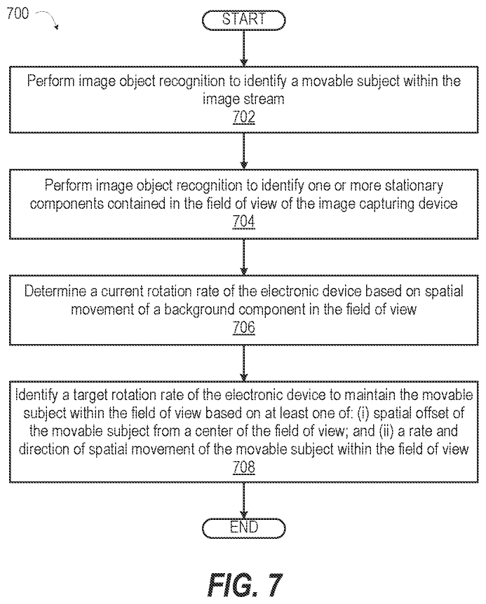

FIGS. 6A-6B (collectively “FIG. 6”) are a flow diagram presenting a method of selectively vibrating an electronic device for bidirectional rotation to track a subject moving within a field of view of an ICD. FIG. 7 is a flow diagram presenting a method of modulating vibration of an electronic device based on a current rotation rate and a target rotation rate to calibrate the rotational tracking of the subject. The descriptions of method 600 (FIG. 6) and method 700 (FIG. 7) are provided with general reference to the specific components illustrated within the preceding FIGS. 1-2, 3A-3B, 4A-4D, and 5A-5C. Specific components referenced in method 600 (FIG. 6) and method 700 (FIG. 7) may be identical or similar to components of the same name used in describing preceding FIGS. 1-2, 3A-3B, 4A-4D, and 5A-5C. In one or more embodiments, controller 150 (FIGS. 1-2) respectively of electronic device 100 (FIG. 1) and communication device 200 (FIG. 2) provides functionality of method 600 (FIG. 6) and method 700 (FIG. 7).

With reference to FIG. 6A, Method 600 includes monitoring a user interface for an image capturing device (ICD) of the electronic device (block 602). Method 600 includes determining whether subject tracking in support of video generation is activated (decision block 604). In response to determining that subject tracking in support of video generation is not activated, method 600 returns to block 602. In response to determining that subject tracking in support of video generation is activated, in one or more embodiments, method 600 includes monitoring movement sensor(s) to determine rotational movement of the electronic device (block 606). In alternate embodiments, the electronic system does not include movement sensor(s), so the monitoring step does not occur. In one or more embodiments, method 600 includes monitoring an image stream from the ICD of the electronic device to determine rotational movement of the electronic system (block 608). An implementation of block 608 is described below in method 700 (FIG. 7). Method 600 includes receiving an image stream from an ICD having a field of view and positioned at an exterior of a housing of an electronic device, the housing positioned on a support surface (e.g., base or stationary surface) (block 610). Then method 600 proceeds to block 612 (FIG. 6B).

With reference to FIG. 6B, method 600 includes determining whether the movable subject is moving laterally in a first direction within the field of view of the ICD (decision block 612). In response to determining that the movable subject is moving in the first direction, in one or more embodiments, method 600 includes determining a vibration modulation level for a first mode using closed loop control based on first direction, rotational movement of the electronic device, and lateral movement of the subject (block 614). Method 600 includes triggering at least one vibratory component received in the housing to vibrate in the first mode that results in the housing rotating in the first direction to maintain the movable subject within the field of view of the ICD (block 616). Then method 600 returns to block 602 (FIG. 6A). In response to determining that the movable subject is not moving in the first direction in decision block 612, method 600 includes determining whether the movable subject is moving in a second direction that is opposite to the first direction (decision block 618). In response to determining that the movable subject is not moving in the second direction, method 600 returns to block 602 (FIG. 6A). In response to determining that the movable subject is moving in the second direction, in one or more embodiments, method 600 includes determining a vibration modulation level for a second mode using closed loop control based on second direction, rotational movement of the electronic device, and lateral movement of the subject (block 620). Method 600 includes triggering the at least one vibratory component to vibrate in the second mode that results in the housing rotating in the second direction to maintain the movable subject within the field of view (block 622). Then method 600 returns to block 602.

With reference to FIG. 7, method 700 includes performing image object recognition to identify a movable subject within an image stream capture by an ICD (block 702). Method 700 includes performing image object recognition to identify one or more stationary components contained in the field of view of the ICD (block 704). Method 700 includes determining a current rotation rate of the electronic device based on spatial movement of a background component in the field of view (block 706). Method 700 includes identifying a target rotation rate of the electronic device to maintain the movable subject within the field of view based on at least one of: (i) spatial offset of the movable subject from a center of the field of view; and (ii) a rate and direction of spatial movement of the movable subject within the field of view (block 708). Then method 700 ends.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation is not limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
a housing configured for positioning on a support surface;
an image capturing device positioned at an exterior of the housing to have a field of view that encompasses a movable subject;
at least one vibratory component received in the housing, and which generates vibratory movement; and
a controller communicatively connected to the image capturing device and the at least one vibratory component, and which:
identifies the movable subject within an image stream received from the image capturing device;
in response to determining that the movable subject is moving in a first direction, triggers the at least one vibratory component to vibrate in a first mode that results in the housing rotating in the first direction to maintain the movable subject within the field of view; and
in response to determining that the movable subject is moving in a second direction that is opposite to the first direction, triggers the at least one vibratory component to vibrate in a second mode that results in the housing rotating in the second direction to maintain the movable subject within the field of view.

2. The electronic device of claim 1, wherein the at least one vibratory component is received in the housing for vibratory movement in at least two modes comprising: (i) the first mode that oscillates a first portion laterally offset from a center of mass of the electronic device; and (ii) the second mode that oscillates a second portion laterally offset opposite to the first portion from the center of mass.

3. The electronic device of claim 1, wherein the controller:
performs image object recognition to identify the movable subject;
performs image object recognition to identify one or more stationary components contained in the field of view;
determines a current rotation rate of the electronic device based on spatial movement of the one or more stationary components in the field of view;
identifies a target rotation rate of the electronic device to maintain the movable subject within the field of view based on at least one of: (i) spatial offset of the movable subject from a center of the field of view; and (ii) a rate and direction of spatial movement of the movable subject within the field of view; and
modulates at least one of a vibration rate and a vibration amplitude of the at least one vibratory component in relation to a difference between the target rotation rate and the current rotation rate to maintain the movable subject within the field of view.

4. The electronic device of claim 1, further comprising a movement sensor configured to detect a movement of the electronic device related to rotation rate and communicatively coupled to the controller, wherein the controller:
determines a target rotation rate of the electronic device to maintain the movable subject within the field of view;
receives, from the movement sensor, a current rotation rate of the electronic device; and
modulates at least one of a vibration rate and a vibration amplitude of the at least one vibratory component in relation to a difference between the target rotation rate and the current rotation rate.

5. The electronic device of claim 1, wherein the housing comprises:
a first housing;
a second housing; and
a hinge coupling the first housing to the second housing, the image capturing device positioned on one of the first and the second housings, the first housing pivotable about the hinge relative to the second housing between a folded closed position and an unfolded open position, the housing positioned on the support surface in one of an L-shaped position and a tent position to present the image capturing device.

6. The electronic device of claim 5, wherein:
the electronic device rotates in the L-shaped position in response to vibrations by the at least one vibratory component;
the first housing comprises a convex portion aligned with a center of rotation of the electronic device and configured to contact the support surface; and
the image capturing device is positioned in the second housing.

7. The electronic device of claim 1, further comprising a base separate from the electronic device and that comprises the support surface, which is positionable upon a stationary surface and has an upwardly presented concave surface to constrain lateral movement of the electronic device.

8. The electronic device of claim 7, wherein:
the housing of the electronic device comprises:
a first housing;
a second housing; and
a hinge coupling the first housing to the second housing, the image capturing device positioned on one of the first and the second housings, the first housing pivotable about the hinge relative to the second housing between a folded closed position and an unfolded open position, the housing positioned on the support surface in an L-shaped position to present the image capturing device; and
the concave surface of the base comprises a central raised portion positioned to the electronic device at a center of rotation of the electronic device.

9. A method comprising:
identifying a movable subject within an image stream received from an image capturing device positioned at an exterior of a housing of an electronic device, the housing positioned on a support surface;
in response to determining that the movable subject is moving in a first direction, triggering at least one vibratory component received in the housing to vibrate in a first mode that results in the housing rotating in the first direction to maintain the movable subject within a field of view of the image capturing device; and
in response to determining that the movable subject is moving in a second direction that is opposite to the first direction, triggering the at least one vibratory component to vibrate in a second mode that results in the housing rotating in the second direction to maintain the movable subject within the field of view.

10. The method of claim 9, wherein the at least one vibratory component is received in the housing for vibratory movement in at least two modes comprising: (i) the first mode that oscillates a first portion laterally offset from a center of mass of the electronic device; and (ii) the second mode that oscillates a second portion laterally offset opposite to the first portion from the center of mass.

11. The method of claim 9, further comprising:
performing image object recognition to identify the movable subject;
performing image object recognition to identify one or more stationary components contained in the field of view;
determining a current rotation rate of the electronic device based on spatial movement of the one or more stationary components in the field of view;
identifying a target rotation rate of the electronic device to maintain the movable subject within the field of view based on at least one of: (i) spatial offset of the movable subject from a center of the field of view; and (ii) a rate and direction of spatial movement of the movable subject within the field of view; and
modulating at least one of a vibration rate and a vibration amplitude of the at least one vibratory component in relation to a difference between the target rotation rate and the current rotation rate to maintain the movable subject within the field of view.

12. The method of claim 9, further comprising:
monitoring a movement sensor configured to detect a movement of the electronic device related to rotation rate positioned at the housing;
determining a target rotation rate of the electronic device to maintain the movable subject within the field of view;
receiving, from the movement sensor, a current rotation rate of the electronic device; and
modulating at least one of a vibration rate and a vibration amplitude of the at least one vibratory component in relation to a difference between the target rotation rate and the current rotation rate.

13. The method of claim 9, wherein the housing comprises:
a first housing;
a second housing; and
a hinge coupling the first housing to the second housing, the image capturing device positioned on one of the first and the second housings, the first housing pivotable about the hinge relative to the second housing between a folded closed position and an unfolded open position, the housing positioned on the support surface in one of an L-shaped position and a tent position to present the image capturing device.

14. The method of claim 13, wherein:
the electronic device rotates in the L-shaped position in response to vibrations by the at least one vibratory component;
the first housing comprises a convex portion aligned with a center of rotation of the electronic device and configured to contact the support surface; and
the image capturing device is positioned in the second housing.

15. The method of claim 9, further comprising a base separate from the electronic device and that comprises the support surface, which is positionable upon a stationary surface and has an upwardly presented concave surface to constrain lateral movement of the electronic device.

16. The method of claim 15, wherein:
the housing of the electronic device comprises:
a first housing;
a second housing; and
a hinge coupling the first housing to the second housing, the image capturing device positioned on one of the first and the second housings, the first housing pivotable about the hinge relative to the second housing between a folded closed position and an unfolded open position, the housing positioned on the support surface in an L-shaped position to present the image capturing device; and
the concave surface of the base comprises a central raised portion positioned to support the electronic device at a center of rotation of the electronic device.

17. A computer program product comprising:
a computer readable storage device; and
program code on the computer readable storage device that when executed by a processor associated with an electronic device, the program code enables the electronic device to provide functionality of:
identifying a movable subject within an image stream received from an image capturing device positioned at an exterior of a housing of the electronic device, the housing positioned on a support surface;
in response to determining that the movable subject is moving in a first direction, triggering at least one vibratory component received in the housing to vibrate in a first mode that results in the housing rotating in the first direction to maintain the movable subject within a field of view of the image capturing device; and
in response to determining that the movable subject is moving in a second direction that is opposite to the first direction, triggering the at least one vibratory component to vibrate in a second mode that results in the housing rotating in the second direction to maintain the movable subject within the field of view.

18. The computer program product of claim 17, wherein the at least one vibratory component is received in the housing for vibratory movement in at least two modes comprising: (i) the first mode that oscillates a first portion laterally offset from a center of mass of the electronic device; and (ii) the second mode that oscillates a second portion laterally offset opposite to the first portion from the center of mass.

19. The computer program product of claim 17, wherein the program code enables the electronic device to provide functionality of:
performing image object recognition to identify the movable subject;
performing image object recognition to identify one or more stationary components contained in the field of view;
determining a current rotation rate of the electronic device based on spatial movement of a background component in the field of view;
identifying a target rotation rate of the electronic device to maintain the movable subject within the field of view based on at least one of: (i) spatial offset of the movable subject from a center of the field of view; and (ii) a rate and direction of spatial movement of the movable subject within the field of view; and
modulating at least one of a vibration rate and a vibration amplitude of the at least one vibratory component in relation to a difference between the target rotation rate and the current rotation rate to maintain the movable subject within the field of view.

20. The computer program product of claim 17, wherein the program code enables the electronic device to provide functionality of:
monitoring movement sensor positioned at the housing and configured to detect a movement of the electronic device related to rotation rate;
determining a target rotation rate of the electronic device to maintain the movable subject within the field of view;
receiving, from the movement sensor, a current rotation rate of the electronic device; and
modulating at least one of a vibration rate and a vibration amplitude of the at least one vibratory component in relation to a difference between the target rotation rate and the current rotation rate.
